(19) United States
(12) Patent Application Publication
(10) Pub. No.: US 2002/0090056 A1
(43) Pub. Date: Jul. 11, 2002

(54) Beam filtering device and method

(76) Inventors: Jean-Pierre Saladin, Bagneux (FR); Serge Louis Muller, Guyancourt (FR); Andreas Rick, Plaisir (FR)

Correspondence Address: General Electric Company, 3135 Easton Turnpike-W3C, Fairfield, CT, 06431, US

(21) Appl. No.: 10/034,803

(22) Filed: Dec. 19, 2001

(30) Foreign Application Priority Data
Dec. 19, 2000 (FR) 0016583

(51) Int. Cl. G21K 3/00

(52) U.S. Cl. 378/157; 378/156

(57) ABSTRACT

A beam filtering device comprises a strip carrying at least one filter. The strip is wound onto drums between which the strip extends. A rotary drive mechanism drives the drums in rotation to cause the strip to advance and wind onto one drum while unwinding from the other. Advancing the strip makes it possible to arrange one of the filters on the strip in the space between the drums. This allows radiation filtering characteristics to be readily and rapidly modified.

### CROSS REFERENCE TO RELATED APPLICATIONS

This application claims the benefit of a priority under 35 USC 119 to French Patent Application No. 00 16583 filed Dec. 19, 2000, the entire contents of which are incorporated by reference.

### FIELD OF THE INVENTION

The invention relates to X-ray apparatus such as mammographs and, more particularly, to filters employed in such apparatus.

### BACKGROUND OF THE INVENTION

In X-ray apparatus, radiation is emitted from a point on a source. The beam constituted by rays of radiation is in the form of a cone directed towards an object or an organ to be examined or towards an X-ray sensitive sensor—for example a photographic plate or digital sensing means. A filtering device is placed between the radiation source and the object or organ to be examined. The filtering device is used to apply filtering to the radiation emitted by the source; the filtration depends on the application, for example on the organ to be examined.

U.S. Pat. No. 4,399,550 discloses a rotary filter for X-ray apparatus. Various curved X-ray filter elements are arranged circularly around a drum. Alternate circumferentially adjacent elements have different filtering properties. Diametrically opposite elements have the same properties. The drum is arranged between the X-ray source and the object or organ to be irradiated, the beam axis passing through the drum axis. Rotation of the drum varies the filtering applied to the X-rays. This device has the disadvantage of being bulky and only allowing use of a limited number of filters.

Another filtering device is disclosed in U.S. Pat. No. 4,896,037. Quarters of a disk have different filtering properties. The disc is driven in rotation by a motor about an axis perpendicular to its surface and passing through its center. The X-ray beam passes through one of the quarters on the disc. Rotation of the disc varies the filtering applied to the X-rays. This device again has the disadvantage of only allowing a limited number of filters and of being somewhat bulky.

### BRIEF DESCRIPTION OF THE INVENTION

There is consequently a need for a filtering device allowing the filtering applied to radiation in X-ray apparatus to be changed rapidly and simply. There is also a need for a filtering device of limited bulkiness and occupying a small space as possible.

Briefly, in one embodiment of the invention, a filtering device employs flexible filters, arranged on a strip. The strip is wound around drums situated at each side of the path of the radiation to be filtered. Unwinding the strip from one drum and winding it onto the other causes advance from one of the filters on this strip to another in the path of the radiation.

### BRIEF DESCRIPTION OF THE DRAWINGS

FIG. 1 is a diagrammatic view in perspective of a filtering device; and

FIG. 2 shows that part of the filtering strip employed in the device of FIG. 1 on a larger scale.

### DETAILED DESCRIPTION OF THE INVENTION

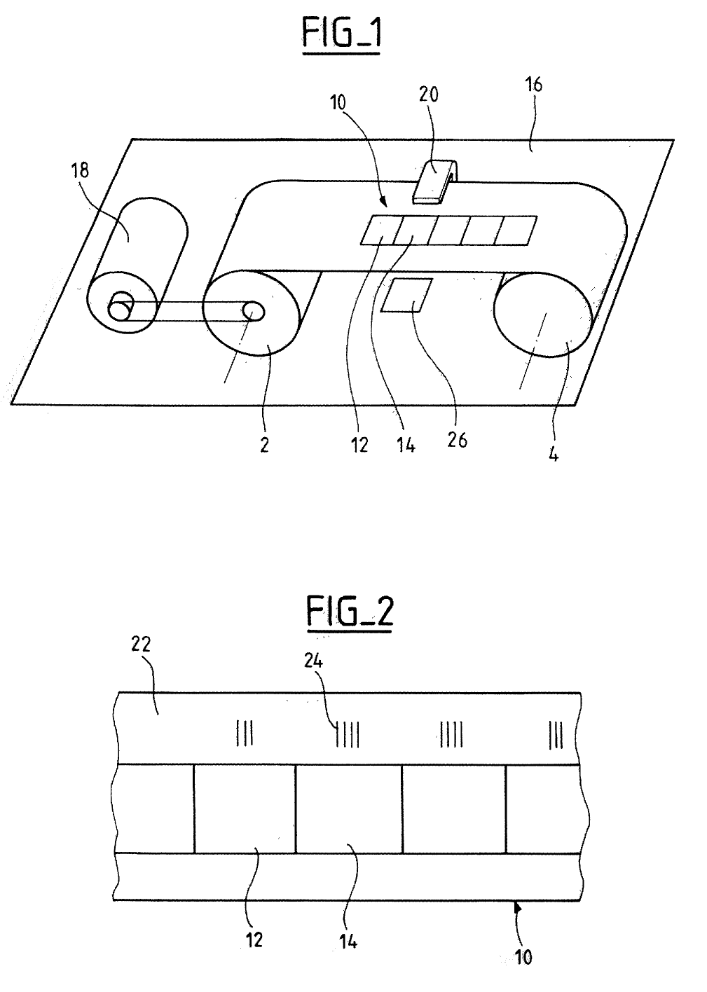

Referring to FIGS. 1 and 2, a filtering device according to one embodiment of the invention will be described. In the embodiment in the drawings, X-ray treatment apparatus will be considered. The filtering device has a first drum 2, and a second drum 4, with its axis parallel to the first drum. The two drums are spaced apart. A space through which beam 6 originating from the X-rays source passes is provided between the two drums. A flexible strip 10 wound on the drums extends across the space. The strip, which is described in more detail with reference to FIG. 2, acts as a carrier for filters 12, 14. Filters 12 are offset along strip 10.

Unwinding the strip from one drum and winding it onto the other allows the filtering applied to X-ray beam 6 to be modified. Moving the strip longitudinally allows one filter on the strip to be located in the space between the drums. The assembly of elements comprising the filtering device, drums, motor—is mounted on a support plate 16 which is not described in detail.

Providing filters on the strip makes it possible to employ a large number of filters in the apparatus. The filter surface area is not intrinsically limited. As the surface area can be increased simply by increasing the length of the strip. Additionally, the device is compact since the winding of the strip onto the drums limits overall bulk of the device. Changing from one filter to another on the strip is fast, by simply advancing the strip.

FIG. 1 further shows an embodiment of a drive mechanism. A motor 18 is linked to one of the drums 2 allowing the drum to be driven in rotation in one direction or the other. The motor 18 can be, for example, a stepping motor. The second drum 4, in the embodiment illustrated, is not driven; however, it can be biased to rotate by spring means not shown in the drawing. Thus, the second drum can wind the strip carrying the filters when the strip is unwound from the first drum. The spring means also ensure the strip is kept tensioned. In the embodiment shown, the strip would then move from left to right. In the other direction, when the strip is wound by the first drum, the second drum is rotated against the bias applied by the spring means. In the embodiment shown, the strip would then move from right to left. Drum diameter depends on the nature of the strip and of the filters, and will be discussed below. Drum spacing depends on the area required for passage of the beam.

FIG. 1 shows the support plate 16 of the filtering device. This plate can have an aperture the size of which substantially corresponds to the size of a filter. If the plate is opaque to X-rays, this aperture limits radiation spillage around the filter. Means for reading 20 are also shown on support plate 16. The plate 16 is fixed with respect to the drums. The means for reading is provided for locating the position of strip 10 and is used to determine which filter is in the path of beam 6. Operation of the means for reading is discussed in detail with reference to FIG. 2.

The filtering device of FIG. 1 operates as follows. The device is arranged in the path of the X-ray beam. For a given exposure, one of the filters on the strip is selected. The strip can now be advanced by winding it onto one drum and unwinding it from the other. Advance can be in either direction depending on the position of the filter to be used on the strip. Advance of the strip is interrupted when the filter to be used is located in the path of the beam. The means for reading can be used to determine filter position. When the strip has stopped with a filter in place, exposure can occur. If, for the next exposure, it is necessary to change the filter, the same strip advance operation is repeated.

FIG. 2 shows part of the filtering strip used in the device of FIG. 1 on a larger scale. The filters 12 and 14 can be seen on the strip 10. More specifically, the strip comprises a carrier 22 in a material transparent to X-rays. The X-ray transparency allows, firstly, non-filtering of the beam by arranging for a filter to be absent from the strip. Secondly, it facilitates filter production. It is not necessary, when designing the filters, to take into account the carrier. The carrier is flexible, in other words can be wound onto a drum without deterioration. A carrier that allows winding onto a drum of a diameter greater than or equal to 20 mm can be used. For the carrier, polypropylene, a polycarbonate, a polypropylene polycarbonate or any other synthetic support can be used. Films sold under the Mylar™ or Kapton™ brand by E. I. Dupont de Nemours are suitable for the carrier. Carrier thickness is simply sufficient to ensure the carrier has a required mechanical strength. A thickness of around 0.1 mm is suitable.

The filters are applied to one or both surfaces of the carrier. They can be deposited on the carrier by vapor phase chemical deposition. Deposition has the advantage of limiting artifacts while ensuring uniform distribution of the products deposited. It is advantageous from this point of view for the carrier surface to provide good mechanical strength vis-a-vis the filter deposited there. The material deposited is a material known as such for filtering such as for example aluminium, rhodium, molybdenum or tungsten.

The filter can typically be 125 μm thick. Greater or lesser thicknesses can be employed for obtaining different filtering properties. The filters can be deposited on one surface of the support or both surfaces. Depositing a filter on both facing surfaces of the carrier has the advantage of limiting filter thickness on the surface for identical filtering characteristics. This limits deposited layer fatigue during winding. Additionally, this configuration decreases the probability of faults being present in the filter, and improves uniformity. Indeed, if both the deposited layers were to include local defects, it is somewhat unlikely that the defects in the deposited layers on both surfaces would coincide. It will be noted that adjacent filters in the embodiment of FIG. 2 are in contact. This makes it possible to change from one filter to another without ceasing to filter the beam. Thus, a filter can be changed without stopping exposure. This filter configuration also ensures the best possible use is made of the available surface on the strip.

A marking 24 provided on the carrier can also be seen in FIG. 2. This marking is read by the means for reading 20. The means for reading 20 can, for example, be a light source/detector using a carrier 22 that is transparent for visible light, the marking being simply printed on the carrier. The marking can also consist of a metal deposition formed at the same time as a filter. Means for reading 20 can also comprise an X-ray detector. In this case, the marking will comprise a material opaque to X-rays. This solution allows the marking to be read in the presence of X-rays but has the disadvantage of preventing reading between exposures. The marking can provide strip location for positioning purposes, allowing the strip to be positioned correctly. It will then indicate the position of the filter. The marking can also, alternatively, identify the nature of a filter: in this case, the type of filter is determined by reading the marking. In both cases, the marking can be located at a predetermined position with respect to the filters. On FIG. 2, the marking is located on an axis of symmetry of filter 12. This is but one example which depends on the position of the reading means with respect to the drums and the beam.

The filtering device applies, for example, to mammographs. The device allows numerous filters to be provided, and allows them to be changed rapidly. Additionally, it occupies a limited space.

Obviously, the embodiments just described can be modified. Thus, each drum can be driven separately with the second drum being driven by a second motor. One can also arrange for the motor to drive both drums simultaneously. In the embodiment illustrated, motor 18 drives drum 2 via a pulley. Other drive arrangements are possible. The means for reading illustrated employs a detector for strip position. The position of a strip can also be located by the position of the drums or via the motor control. This embodiment obviates the need to calibrate the filtering device. Position location using a combination of the motor and reading means can be used. In the example illustrated, the strip is wound in the same direction onto both drums. The strip extends parallel to the plane formed by the axes of the drums. The strip could equally as well be wound in opposite senses on the two drums. In this case, the strip would run on a plane intersecting the plane formed by the axes of the drums. Such an arrangement could be useful for space saving in the filtering device.

Various modifications in structure and/or steps and/or function may be made by one skilled in the art without departing from the scope and extent of the invention as recited in the claims.

What is claimed is:

1. A beam filtering device comprising:
a strip carrying at least one filter;
two spaced drums onto which the strip is wound and between which the strip extends; and
a means for driving at least one of the drums (2) in rotation.

2. The device of claim 1, comprising
means for reading in a fixed position with respect to the drums; and
a marking on the strip readable by the means for reading.

3. The device of claim 2, wherein the marking indicates the position of a filter.

4. The device of claim 2 wherein the marking indicates the nature of a filter.

5. The device of claim 3 wherein the marking indicates the nature of a filter.

6. The device of claim I in which the two drums are mounted on a support opaque to radiation, having an aperture.

7. The device of claim 2 in which the two drums are mounted on a support opaque to radiation, having an aperture.

8. The device of claim 3 in which the two drums are mounted on a support opaque to radiation, having an aperture.

9. The device of claim 4 in which the two drums are mounted on a support opaque to radiation, having an aperture.

10. The device of claim 6, in which the aperture has substantially the size of a filter.

11. The device of claim 7, in which the aperture has substantially the size of a filter.

12. The device of claim 8, in which the aperture has substantially the size of a filter.

13. The device of claim 9, in which the aperture has substantially the size of a filter.

14. The device of claim 1 wherein the strip carries at least two filters, the filters being in contact.

15. The device of claim 2 wherein the strip carries at least two filters, the filters being in contact.

16. The device of claim 3wherein the strip carries at least two filters, the filters being in contact.

17. The device of claim 4 wherein the strip carries at least two filters, the filters being in contact.

18. The device of claim 5 wherein the strip carries at least two filters, the filters being in contact.

19. The device of claim 6 wherein the strip carries at least two filters, the filters being in contact.

20. The device of claim 14 wherein the strip carries at least two filters, the filters being in contact.

21. The device of claim I wherein the strip has a carrier to the surface of which a filter is applied.

22. The device of claim 2 wherein the strip has a carrier to the surface of which a filter is applied.

23. The device of claim 3 wherein the strip has a carrier to the surface of which a filter is applied.

24. The device of claim 4 wherein the strip has a carrier to the surface of which a filter is applied.

25. The device of claim 5 wherein the strip has a carrier to the surface of which a filter is applied.

26. The device of claim 6 wherein the strip has a carrier to the surface of which a filter is applied.

27. The device of claim 14 wherein the strip has a carrier to the surface of which a filter is applied.

28. The device of claim 21, wherein a filter is applied to two facing surfaces of the strip.

29. Apparatus having a source of radiation and a filtering device according to claim 1.

30. A method for filtering radiation from a source comprising the steps of:
providing a filtering device with a strip carrying at least one filter and two spaced drums on which the strip is wound and between which the strip extends, the path of the radiation passing between the two drums; and
driving at least one of the drums in rotation for bringing a filter into the path of the radiation.

31. The method of claim 30, wherein the filtering device comprises means for reading in a fixed position with respect to the drums, and a marking on the strip readable by the reading means, the method including the step of positioning the filter by reading the marking.

32. The method of claim 30 wherein the filtering device comprises means for reading in a fixed position with respect to the drums and a marking on the strip readable by the reading means, the method including determining the nature of a filter by reading the marking.

32. The method of claim 31 wherein the filtering device comprises means for reading in a fixed position with respect to the drums and a marking on the strip readable by the reading means, the method including determining the nature of a filter by reading the marking.
